(19) United States
(12) Patent Application Publication
(10) Pub. No.: US 2013/0232082 A1
(43) Pub. Date: Sep. 5, 2013

(54) Method And Apparatus For Secure Medical ID Card

(71) Applicants: Mark Stanley Krawczewicz, Annapolis, MD (US); Kenneth Hugh Rose, Annapolis, MD (US)

(72) Inventors: Mark Stanley Krawczewicz, Annapolis, MD (US); Kenneth Hugh Rose, Annapolis, MD (US)

(21) Appl. No.: 13/786,418

(22) Filed: Mar. 5, 2013

Related U.S. Application Data
(60) Provisional application No. 61/606,564, filed on Mar. 5, 2012.

(51) Int. Cl. G06F 19/00; G06Q 50/22

(52) U.S. Cl. CPC G06F 19/324; G06Q 50/22
USPC 705/55

(57) ABSTRACT

A method for storing medical data on a secure ID card and retrieving the medical data from the card using an authentication device. The method comprises the steps of verifying the card and the authentication device, unlocking in the card a user password template stored in the card in response to verification of the card and authentication device, inputting a password, transmitting the password to the card, comparing the inputted password to the unlocked password template, unlocking a biometric template stored in the card in response to a positive comparison, capturing biometric data a person with the biometric sensor, generating in the authentication device a biometric template through processing of the captured biometric data, transmitting the template to the card, comparing the biometric template to the unlocked template, generating a decryption key, and using the decryption key to unlock a medical application on the authentication device.

### CROSS-REFERENCE TO RELATED APPLICATIONS

The present application claims the benefit of the filing date of U.S. Provisional Patent Application Ser. No. 61/606,564 filed by the present inventors on Mar. 5, 2012.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The present invention relates to secure medical ID cards, and more specifically, secure medical ID and medical insurance cards having a display for displaying medical data.

2. Brief Description of the Related Art

A variety of systems and methods for secure authentication using a token have been used in the past. Such smart tokens may be in the form of smartcards, USB tokens or other forms. Conventional smartcards typically are credit-card sized and made out of flexible plastic such as polyvinyl chloride. Smartcards have been used in wide varieties of applications, such as identification badges, membership cards, credit cards, etc. Conventional USB token are typically small and portable and may be of any shape. They are embedded with a micromodule containing a silicon integrated circuit with a memory and a microprocessor.

Traditional plastic card ID credentials rely on printed inks and tamper evident materials like holograms, printed static 2D barcodes, and passwords for security and to protect user data from modifications. To verify these traditional cards, readers employ multimodal optical and wavelength sensors in an attempt to verify a user's identity printed on the card.

Smartcards can be either “contact” or “contactless.” Contact cards typically have a visible set of gold contact pads for insertion into a card reader. Contactless cards use radio frequency signals to operate. Other smart tokens connect to other devices through a USB or other communications port.

Smart cards typically may have information or artwork printed on one or both sides of the card. Since smart cards are typically credit card sized, the amount of information that may be displayed on a smartcard is typically limited. A number of efforts have been made to increase the amount of data that may be displayed on a smartcard. For example, U.S. Pat. No. 7,270,276 discloses a multi-application smartcard having a dynamic display portion made, for example, of electronic ink. The display on that card changes from a first display to a second display in response to an application use of the smartcard. Another example is U.S. Patent Publication Serial No. US2005/0258229, which disclosed a multi-function smartcard (also known as an “integrated circuit card” or “IC card”) with the ability to display images on the obverse side of the card.

A display of images on a flexible display within a card typically implements an active pixel matrix display type display which has the ability to show 8 or more degrees of gray scale on each pixel. The two dimensional array of these gray scale pixels generate an image of a cardholder face. A segmented type flexible display has only two states (black or white). A group of seven segments will comprise any single digit number whereas a group of 14 segments will denote any alphabetic or numeric letter or digit. The display and control circuitry is much more simplistic for segmented displays than for active matrix displays. The present application addresses only segmented flexible bi-state displays for secure ID credentials.

Access control stations typically located on the boundary of the security area or building use some method to verify or authenticate the uses who are allowed access. The general methods to authenticate include one or more of the following defined as 1, 2, or 3 factor authentication:
1. What you have—a card or ID machine or visually checked by a guard
2. What you know—a password typed into a keypad
3. What you are—a physical biometric attribute comparing a pre-stored “template” to a live scan using some hardware at the access control station

There are many shortfalls and added system complexities for implementing these access control methods like; user data must be stored on a database or within the card securely, cards can be duplicated or lost, passwords can be hacked, biometrics are difficult and costly to store and scale to larger access control networks.

More recently, biometric thumb drive tokens and smartcards have proven ineffective and non-secure. These shortcomings vary but complexity, scalability, and interoperability are common causes. It was found that biometrics are challenging to enroll and deploy when the user's information is stored and retrieved on a central database.

Other shortfalls with 3-factor authentication using cards and access control portals are portability, scalability, and verification the machine-based authentication actually happened. This part of the transaction is usually completely transparent to the user and/or verifying official until the end of the process.

Recently, efforts have been made to incorporate displays into RFID cards and tags. For example, in U.S. Patent App. Pub. No. 2010/0052908 entitled “Transient State Information Display in an RFID Tag,” a display is incorporated into an RFID card to show a transient state such as an age of a product. In the preferred embodiment disclosed in that patent, a card or tag reader provides a current date while the card provides the expiration date of the product. Based on a comparison of those two, an LED is illuminated to reflect the status of the product. The disclosure indicates that a variety of other types of displays may be used and also that the card may be active or passive. In another example, U.S. Patent App. Pub. No. 2010/0079416 entitled “Radio Frequency Identification (RFID), Display Pixel, and Display Panel and Display Apparatus Using RFID Display Pixel” discloses an RFID tag connected to an “RFID pixel” or plurality of “RFID pixels.” Another example is described in U.S. Patent App. Pub. No. 2009/0309736 entitled “Multifunction Contactless Electronic Tag for Goods.”

### SUMMARY OF THE INVENTION

In a preferred embodiment, the present invention is a method for storing medical data on a secure ID card and retrieving the medical data from the secure ID card using an authentication device. The authentication device has a biometric sensor, a display, an input device and an RFID reader. The secure identification card has a display, a secure processor, a memory, and an antenna for communicating with the RFID reader. The method comprises the steps of verifying the card and the authentication device by executing a mutual challenge response algorithm between the secure ID card and the reader, unlocking in the secure ID card a user password template stored in the secure ID card in response to verification of the secure ID card and the authentication device, inputting a password into the authentication device, transmitting the password to the secure ID card, comparing in the secure processor the inputted password to the unlocked password template, unlocking a biometric template stored in the secure ID card in response to a positive comparison of the inputted password and the unlocked password template, capturing biometric data a person with the biometric sensor, generating in the authentication device a biometric template through processing of the captured biometric data, transmitting the generated biometric template to the secure ID card, comparing in the secure processor the generated biometric template to the unlocked biometric template, generating a decryption key in response to a positive comparison of the generated biometric template to the unlocked biometric template; and using the decryption key to unlock a medical application on the authentication device. The method may further comprise selecting through the input device on the authentication device to display selected medical information on the secure ID card, transmitting to the secure ID card an instruction to display the selected medical information on the display on the secure ID card and causing the display on the secure ID card to display the selected medical information.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a schematic drawing of a secure medical ID card in accordance with a preferred embodiment of the present invention.

FIG. 2A is an illustration of a prior art secure ID card.

FIG. 2B is an illustration of a secure medical ID card in accordance with a preferred embodiment of the present invention.

FIG. 3A is an illustration of a secure medical ID card in accordance with a preferred embodiment of the present invention.

FIG. 3B is an illustration of a secure medical insurance card in accordance with a preferred embodiment of the present invention.

FIG. 4 is an illustration of a secure medical insurance card in accordance with a preferred embodiment of the present invention.

FIG. 5 is an illustration of a secure ID card and physician's interface device in accordance with a preferred embodiment of the present invention.

FIG. 6 is an illustration of a secure medical insurance card and various data that may be displayed in accordance with a preferred embodiment of the present invention.

FIGS. 7A and 7B are flow diagrams illustrating use of a secure medical ID in accordance with a preferred embodiment of the present invention.

### DETAILED DESCRIPTION OF THE PREFERRED EMBODIMENTS

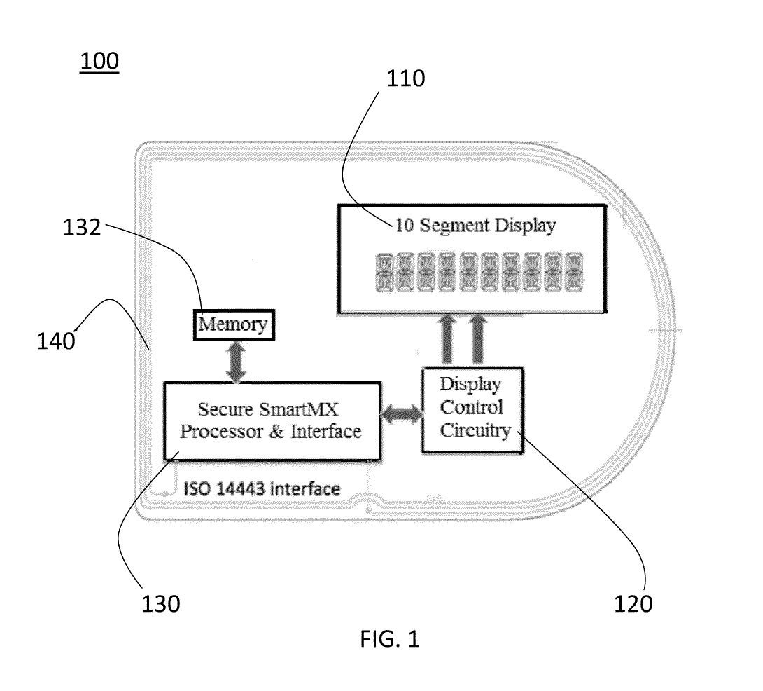

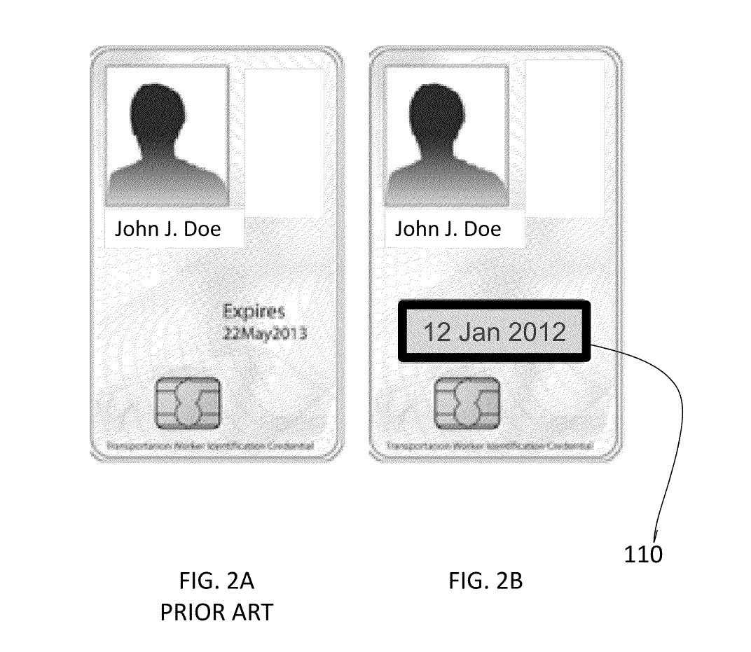

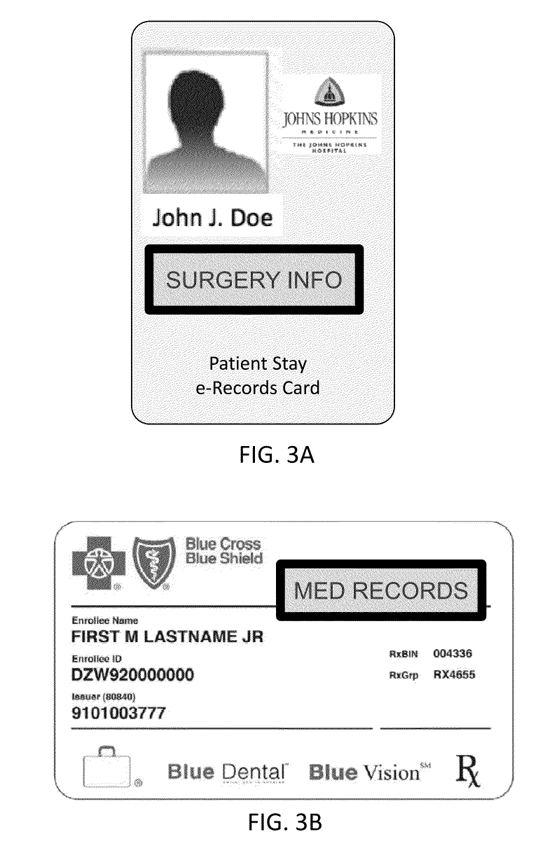

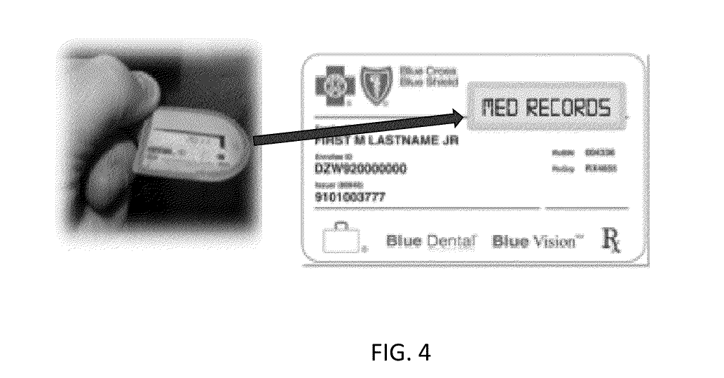

The Secure ID Credential Card with display of the present invention is described with reference to FIGS. 1-7. As shown in FIG. 1, the secure medical ID has a thin flexible display module 100 encapsulated in a plastic laminate to form a secure medical ID card or insurance of the present invention. The card has a display 110, which, for example, may be a ten segment display. The display is connected to display control circuitry 120 and secure SmartMX processor and interface 130. The card may have expanded memory 132 to store greater amounts of data, such as X-rays, sonograms, MRI's and other medical images. The card further has an RFID antenna 140. The secure medical ID card of the present invention may take many different forms, such as shown in FIGS. 2B, 3A, 3B and 4.

This display module provides many unique features that are particularly advantageous in a number of different security applications. Examples of these are:

Acting as an electronic locking and unlocking mechanism for physical access to facilities and logical access to computer networks and databases, including remote access using Smart phones, tablets or laptops. The display provides data to the user about the state of the process.

Acting as a secure container for personal data, medical records, business data, passwords as well as other sensitive personal and business records. It also displays information needed to ensure the integrity of this data and its confidentiality. Audit trails can also be stored on the Card.

The architecture of the card is quite simple yet sophisticated, containing all of the features needed to implement trustworthy security for all of its actions and protections for its contents.

The RFID I/O for the battery-less card is implemented with NFC standards (ISO 14443), which provides high-speed bi-directional data transfers as well as providing power for the card components. The secure microprocessor, the SmartMX, contains many security hardware and software features and is used in large quantities for Smartcards, Passports and other Token applications. The display incorporated uses Kindle technology, is bi-stable in that it can only be changed by an NFC reader and will maintain its previous state with no power applied.

The memory for the Card is protected by the SmartMX microprocessor, such that it is only accessible by exercising valid access control procedures. These include successful identification (PIN and/or Biometric) and authentication of the person (i.e. the physician or medical personnel) administering care or medication, requesting access to the patient files and records. Only authorized or approved personnel can have then opens the memory and establishes a secure connection between the card and the RFID-NFC reader.

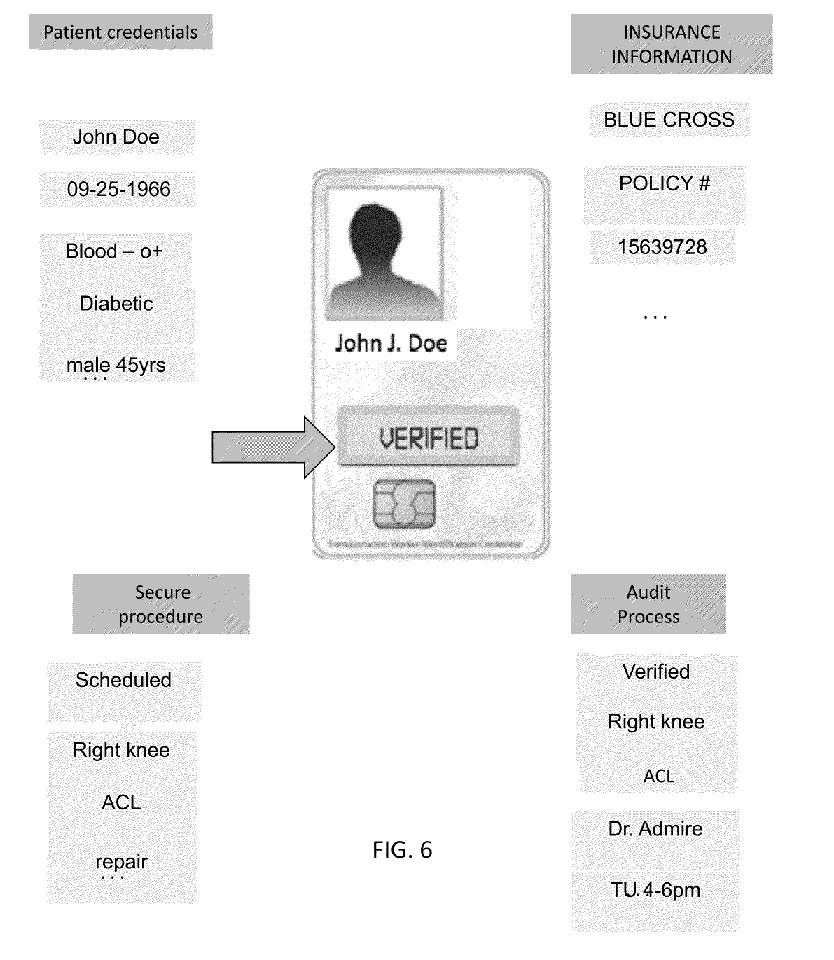

The card is powered and all data written to the card's internal memory and display is done through a commercial interface called Near Field Communications (NFC), as shown in FIG. 6 allowing the card to last indefinitely. NFC is used widely in banks, transit, computer, and mobile devices. A typical method for physicians and care providers to review the patient's medical records, order medication, update medical records, and more would be through a commercial smartphone, iPad, or other mobile device.

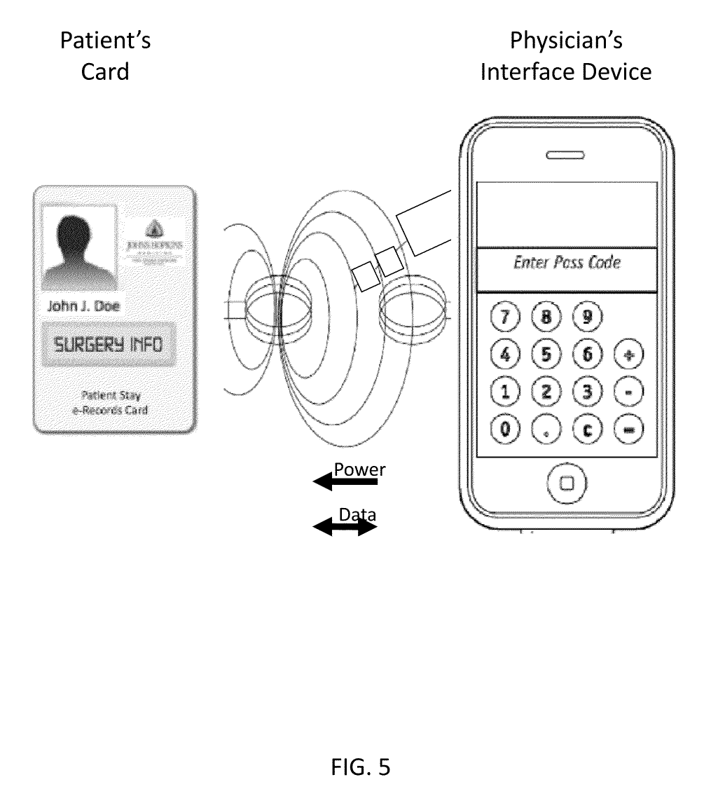

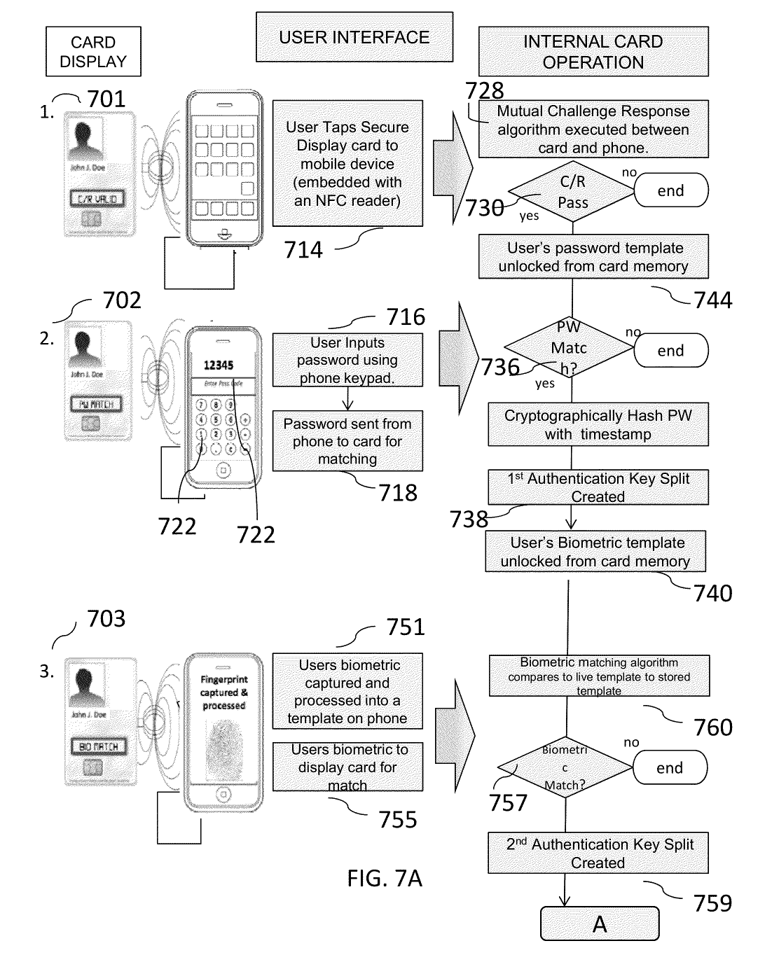

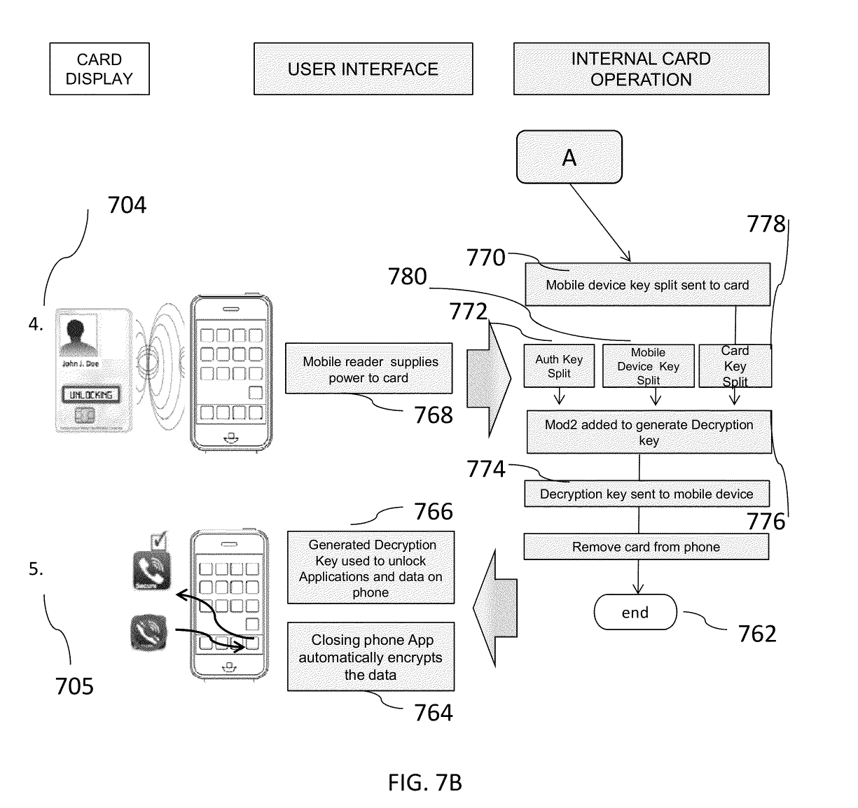

As shown in FIG. 5, the secure medical ID communicates with, for example, a physician's interface device, such as a cell phone, laptop computer, iPad, or other mobile device. Communications between the secure medical ID and the physician's device are shown in FIGS. 7A and 7B, which illustrate five stages 701-705 of communications. In the first stage 701, a mutual challenge response algorithm 728 is executed between the card and the phone. To being the process 714, the patient's card is tapped to the mobile device, which is equipped with an NFC reader. If the challenge and response algorithm is not passed at 730, the process ends. If the challenge and response algorithm is passed at 730, the user's password template is unlocked from the card memory at 744.

In the second stage 702, the user then inputs their password using the mobile device keypad at 716. The password is passed to the card for matching at 718. The secure processor in the card performs matching at 736. If the password is not a match, the process ends. If the password is a match, the secure processor cryptographically hashes the password with a timestamp. A first authentication key is then created at 738 and the user's biometric template is unlocked from the card memory at 740.

In the third stage 703, the user's biometric data is captured and processed into a template on the mobile device at 751. The user's biometric template is sent to the card for matching at 755. A biometric matching algorithm runs on the processor at 760 to compare the user's live biometric template to a template stored on the mobile device. The biometric may be, for example, a fingerprint or an iris or other biometric positively identifying the user. If the biometric is not a match at 757, the process ends. If the biometric template is a match, a second authentication key split is created at 759.

At the fourth stage, the mobile reader supplies power to the card at 768. The mobile device key split is sent to the card at 770. The split includes the authentication key split 772, the mobile device key split 780 and the card key split 778. Mod2 is added at 776 to generate a decryption key. At 774, the decryption key is sent to the mobile device.

At the fifth stage 705, the generated decryption is used to unlock the data and applications on the mobile device at 766. Closing the application on the mobile device automatically causes the device to encrypt the data.

### Data and Audit Applications:

There are two types of data that would normally be stored in the Secure Memory, static data and audit data. Both have to be kept in secure memory but for different reasons.

The Static data is information that needs to be kept confidential, not to be revealed to unauthorized parties but is not subject to audit. Examples of static data that could be stored in the Secure Memory are: identification and authentication information, authorization data, keying information (including Private Keys), Certificates, Credential information, allowable transactions, data collection, record keeping of any sort, personal data repository, medical records, personnel records, passwords storage, integrity checks, logs of unsuccessful access attempts.

A second type is audit data. In Auditing, the concern goes beyond keeping the data confidential, but how and why it was collected. It involves such particulars as independent monitoring of controls, procedures, transaction history and use of resources.

The Audit Trail is the sequence of events occurring that concern the item being audited. One of the more important aspects of auditing is the security of the auditing information and audit trail.

Audit Security is the protection of these audits from modifications for future trusted (provable) review. Without adequate security of this information, it is difficult to prove without a doubt that it has not been modified.

The data in the Secure Memory of the Secure ID Credential Card is protected to the extent that it could be used to support any audit process. Only authenticated persons can view the audit data on the Secure Display. It can also be downloaded to remote databases for further analysis and long-term storage.

Features of the Secure ID Card that would lend themselves to medical applications include the following:

Ability to maintain a secured audit trail

Storage and display of personal and professional credentials

Storage and display of records, personal and administrative information

Access to external databases, local or remote

Allows access to Secure Card display only on authenticated request

Multiple applications maintained on same card

There are many potential areas in medical care in which the Secure ID Card could provide a service. They can be divided into three major categories of applications: Patient oriented, Physician support and those that sustain Critical Health systems.

For successful outcomes in each of these areas, the Card's use needs to be easily understood, integrated into existing systems and supported by knowledgeable personnel. And for the most part, these applications are evolutionary, not requiring replacement but complimenting present techniques. The secure medical ID card of the present invention is further understood from the following examples.

### Example 1

### Patient Support

A number of uses involve assistance to a patient by guiding the patient through required procedures with ease, safety and a minimum amount of errors. Enhanced patient care benefits both the patient and the hospital. Although it usually is applied in a hospital or clinic environment, the Card can also be used for home monitoring. It can also be used for record keeping, medical, financial and process records.

It begins with patient registration and identification. It is an electronic substitute for a patient wristband, except one with much more capability in records storage and security. It can be configured either in card form, as a wrist band or as a separate token that can be adhered to a records container, medical devices or equipment, as discussed below. When a patient checks into a facility, administrative staff registers him with personal information, insurance data and procedures to be performed. If a medical procedure were to be performed it would specify the type of surgery, its nature and location, and other pertinent information as is shown in FIG. 6. It could also include a current medication list, medical history, allergies and other pertinent data needed as background for the visit such as the primary care physician, case manager and scheduling information. This is all protected by the Secure Memory, only to be read by a select list of caregivers and modified by the case manager or primary care physician, all with appropriate password or other access mechanisms. Any subsequent changes to this data would also be recorded on the Card. And if the amount of information were beyond the capacity of the Card, it would provide the unlock key to the confidential storage location within the hospital memory system.

Once the Card has been initialized, it now can be used for patient tracking and support of the procedures to be performed. Fixed RFID readers located at strategic spots throughout the hospital as well as mobile devices can track patient location and read relevant data for each department visited. The patient as well as the hospital can use the Secure display as a guide, with appointment times and places to be visited. Test results can be downloaded to the secure memory. Case managers can securely read results and progress and make appropriate changes or additions. Alerts to the patient for schedule changes or additional tests could result if needed.

One powerful application of the Card could be resource monitoring or allocation for the patient. Accumulation of costs against deductibles is one example, in effect using it as a debit card. Another would be safety related by keeping audit trails of medications provided, type and quantity. Similarly, accumulations of dangerous procedures such as radiation processes can be monitored with visual alerts to caregivers when limits are exceeded.

### Example 2

### Physician/Caregiver Support

Since the Card represents a patient database independent of but synchronized with the hospital records, it can be alternately used in cases of computer network or power outages. Since the Card would be updated during every swipe, synchronization would always be current. It can be used to transfer patient specific and critical data between departments and even between hospitals in case of patient transfers that might be needed when a local area emergency such as Hurricane Katrina occurs.

The Card can be used as an Unlocking device for tools that a Caregiver or Medical technician might need, tools such as a smartphone or an iPad. The smartphone could be used for remote access to information sources and an iPad could contain instruction manuals for procedures or use of medical equipment. Use of the Card would assure that only those with suitable credentials could make use of these tools or view data contained within. Large enterprises such as IBM and Medtronic are now creating internal app stores that ensure that authorized users get the apps for their mobile devices that match their device models and job responsibilities. It's a strategy built around security, productivity and convenience that could be enhanced by the use of the Card. Prescription writing and transmittal to pharmacies are a perfect example of how these devices and apps can be used.

The Card can aid in home care procedures following discharge. Tele-monitoring a homebound patient via smartphone could reduce un-necessary hospital re-admissions. The ability to securely remotely access the patient's Card memory via the network would enable these applications. It would result in virtual visits, less face-to-face time with the doctor needed thereby improving efficiency. The use of the Card could also be integrated into the use of Medical Web Portal systems coming into fashion now for added security and more patient services.

There are also significant impacts on the hospital administrative process. Information from multiple databases can be independently maintained and managed on the Card since the card memory can be segmented with independent security for each segment. This minimizes repeated accesses for the same information and increases overall patient privacy and security. Consider the overlap between medical data, diagnosis and financial or insurance processes and the need for isolation.

Another important administrative process that can be enhanced through the use of the Card would be that of proving the credentials of medical personnel providing care giving service. Nurse's and Doctor's certificates and validity dates could be proven visually on the Card display. A chief Surgeon, for example, could on-the-spot examine the credentials of all those in support positions in the operation theater. Audit trails would then be kept to prove that all personnel were qualified and procedures used (as provided by the iPad) were suitable.

In this era of attempts to save costs in Medicare, an attractive use of the Card from the Caregiver's standpoint would be use it to prove time spent in any procedure. Auditable time records can be kept for graduated and increased medical practice compensations. And as mentioned above, the Caregiver's time spent can become much more efficient and cost effective when using virtual patient visits remote monitoring such as in the home healthcare scenario.

### Example 3

### Critical Healthcare System Support

The discussions thus far have been on the use of the Card by Physicians, Caregivers and Patient themselves to enhance encounters with the medical world. There is a third category of Card use that can have equally important ramifications.

Non-personnel records such as medicine expirations, equipment calibration dates and software updates versions are examples of medical systems that also could be monitored using the Card. It should be noted that the Card can be implemented either in card form or as a Token integrated into an equipment or medicine dispensing unit. In these cases the information of interest is kept on the Card attached to the target equipment. In the Surgical example above, a smartphone could be used to interrogate all equipment for calibration and software currency information to be used in the process, with the results included in the audit records. In the case of dispensing medications, smartphones could also be used with the Card/Tokens on the dispenser to assure that the expiration dates have not been exceeded.

One needs to remember that only those with suitable authority can change or observe the contents of the Card memory. This assures the integrity of all these applications and minimizes the opportunities for mischief or mistakes.

The list of medical applications for the Secure ID Credential Card is extensive and limited only by the imagination of the developers and medical experts. Some exemplary application include the following:

Patient tracking and process monitoring

Patient medical data storage, recording test results

Carrying a list of current medications, dosages, frequency and renewal dates

Monitoring use of expendable or renewable resources

Maintenance of an audit trail for critical medical systems/equipment/medicine use

Medical personnel-display of authority & certification credentials

Serve as an alternate data source during power outages

It should be noted, however, that these uses must be implemented with care and attention to integrating them smoothly into existing systems. The inclusion of this new technology is evolutionary since it does not require changes to the present workflow but rather compliments it by adding security and robustness. And most importantly, it puts more control of the pertinent parts of the process in the patient's hands, where it belongs.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for storing medical data on a secure ID card and retrieving said medical data from said secure ID card using an authentication device having a biometric sensor, a display, an input device and an RFID reader and a secure identification card having a display, a secure processor, a memory, and an antenna for communicating with said RFID reader, the method comprising the steps of:
verifying said card and said authentication device by executing a mutual challenge response algorithm between said secure ID card and said reader;
unlocking in said secure ID card a user password template stored in said secure ID card in response to verification of said secure ID card and said authentication device;
inputting a password into said authentication device;
transmitting said password to said secure ID card;
comparing in said secure processor said inputted password to said unlocked password template;
unlocking a biometric template stored in said secure ID card in response to a positive comparison of said inputted password and said unlocked password template;
capturing biometric data a person with said biometric sensor;
generating in said authentication device a biometric template through processing of said captured biometric data;
transmitting said generated biometric template to said secure ID card;
comparing in said secure processor said generated biometric template to said unlocked biometric template;
generating a decryption key in response to a positive comparison of said generated biometric template to said unlocked biometric template; and
using said decryption key to unlock a medical application on said authentication device.

2. A method for storing medical data on a secure ID card and retrieving said medical data from said secure ID card further comprising:
selecting through said input device on said authentication device to display selected medical information on said secure ID card;
transmitting to said secure ID card an instruction to display said selected medical information on said display on said secure ID card; and
causing said display on said secure ID card to display said selected medical information.
